(19) United States
(12) Patent Application Publication
(10) Pub. No.: US 2021/0027128 A1
(43) Pub. Date: Jan. 28, 2021

(54) ULTRA-LOW POWER CIRCUIT FOR AN EVENT-RECORDING SMART LABEL

(71) Applicant: TIMESTAMP LTD., Hod HaSharon (IL)

(72) Inventor: Aharon Futterman, Netanya (IL)

(21) Appl. No.: 17/040,318

(22) PCT Filed: Mar. 21, 2019
(86) PCT No.: PCT/IL2019/050318

§ 371 Date: Sep. 22, 2020

Related U.S. Application Data
(60) Provisional application No. 62/646,393, filed on Mar. 22, 2018.

(51) Int. Cl. G06K 19/07; H04B 5/00

(52) U.S. Cl. CPC G06K 19/0705; G06K 19/0723; G06K 19/0717; H04B 5/0062

(57) ABSTRACT

The invention provides an ultra-low power circuit for an event-recording smart label, the circuit comprising one or more sensors, a processor comprising a power controller, a power source, and a module comprising a non-volatile memory. The power controller supplies the module with power when needed by the non-volatile memory, for storage of an event log of a sensed event to the non-volatile memory by the processor, and discontinues supplying the module with power after completion of writing the log to the non-volatile memory. The module can be an NFC/memory chip. The module may further comprise a display driver such as one used for driving an e-paper display, wherein the supplying of power is discontinued upon completion of both writing the log and updating the display. A normally unpowered module supplied with power when needed, as taught herein, can provide a significant increase in shelf life over a continuously powered module.

### FIELD OF THE INVENTION

The invention relates to sensor circuits, and in particular to a power-saving circuit for a sensed-event smart label.

### BACKGROUND TO THE INVENTION

An RFID tag is a type of smart label comprising a memory module (typically containing a product ID to identify the product they are adhered to) and an RF circuit which enables the wireless reading and/or writing of the contents of the memory module by a reader. In the case of an RFID tag, the electronics of the smart-label is a passive circuit, where power from the reader enables the transmission of the data in the memory via RF to an adjacent reader. The data output in this case is typically just a product ID, a price, or other information about the product.

Event-recording smart-labels are electronic labels which combine some kind of sensing capability together with storage capability and wireless readability. More sophisticated smart-labels may include some type of sensing circuit—for example a temperature sensor for accumulating the product deterioration over time, or a touch sensor for monitoring handling or use—as well as memory, usually non-volatile memory, for recording logs of sensed events. Such labels require a power source, and therefore employ active as opposed to passive electronics. The output of such a smart-label may employ short to mid-range RF communications like NFC, Bluetooth, Zigbee or WiFi, and/or some kind of visible indicator or display as part of the label.

As smart labels are typically paper-like objects which are thin and adhere easily to the product to which they are attached, they are limited in the extent to which they can incorporate a powerful battery. Accordingly, a major design challenge in the development of active smart-labels is the tradeoff between label thickness and the functionality that needs to be supported over the required shelf life. In particular, it is important to optimize the way in which the components on the PCB in the smart label are powered, so as to minimize the power drain during the active life of the smart label.

A number of schemes exist in the prior art for minimizing the current drain used within a sensed-event recorder.

U.S. Pat. No. 5,625,569A discloses a low power flow measuring apparatus, including a battery for generating a supply signal, a power management unit for producing from the supply signal a first voltage signal that is always enabled and a second and third voltage signal that are selectively enabled, a sensor powered by the third voltage signal for generating a data signal representative of a magnitude of a predefined parameter, and a controller in communication with memory and the sensor and powered by the second signal, for controlling a reading of the data signal from the sensor and the storage of a data value corresponding to the data signal in memory. Interrupt logic, powered by the first voltage signal, activates the power management unit, upon the occurrence of a predefined event, to enable the second and third voltage signals, thereby enabling the controller to take a reading from the sensor. After a reading is taken and the data value written to memory, the power management unit disables the second and third signals to save power. A serial data link is also provided to retrieve collected data values.

However, there is a long-felt but unmet need for the implementation of a sophisticated non-passive smart-label which is active over a number of months while minimizing battery size requirements.

### SUMMARY OF THE INVENTION

The present invention provides an ultra-low power circuit for an event-recording smart label, in which a processor causes a normally unpowered module comprising a non-volatile memory to be supplied with power when needed for writing an event log of a sensed event to the non-volatile memory.

In some embodiments of the invention, a sensor and processor monitor a physical quantity for a sensed event of interest. When a sensed event occurs, the processor writes a log of the sensed event to a non-volatile memory. During monitoring of the physical quantity, the non-volatile memory requires power only while the processor is writing a log of a sensed event to the non-volatile memory. The non-volatile memory can be part of a module which, like the non-volatile memory, does not require power between sensed events during monitoring of the physical quantity. The module can include more than one device, such as an NFC/memory chip and a driver for a display, such as an e-paper display, that updates displayed content upon occurrence of a sensed event. The processor comprises a power controller that causes power to be supplied to the module when needed.

In some embodiments of the invention, a processor of an event-recording smart label writes a log of a sensed event to an EEPROM in an NFC/memory chip of the event-recording device. The NFC/memory chip needs power 1) for the EEPROM, when the processor writes an event log to the EEPROM (during monitoring of the physical quantity) and; 2) for the EEPROM and a transmitter, when offloading the event logs to an NFC reader, wherein reading of event-log data from the EEPROM and transmitting the data to the NFC reader occur. The present invention enables three different supplied-power modes of the NFC/memory chip: 1) Non-powered (off) between sensed events; 2) powered by an internal power source (e.g., a battery) during writing a log of a sensed event to the EEPROM; and 3) powered by the NFC/memory chip harvesting RF radiation transmitted from the NFC reader, in order to transfer sensed event logs from the recording device to the NFC reader.

### BRIEF DESCRIPTION OF THE FIGURES

FIG. 1 shows a general block diagram of an ultra-low power event-recording smart-label circuit, according to some embodiments of the invention.

FIG. 2 shows a general block diagram of an ultra-low power event-recording smart-label circuit, according to some embodiments of the invention.

FIG. 3 shows an electrical schematic of an event-recording smart-label circuit, using an approach for supplying power to integrated circuit chips that is typically used in the prior art.

FIG. 4 shows an electrical schematic of an ultra-low power event-recording circuit according to some embodiments of the invention.

FIG. 5 shows a physical layout of an ultra-low power event-recording smart label, according to some embodiments of the invention.

### DETAILED DESCRIPTION

A published international patent application with international publication number WO/2017/22142, to Holtz and Futterman, discloses a usage recording device. The publication and subject matter originating therefrom published in any national stage application are herein incorporated by reference to the present patent application.

Non-limiting embodiments of the present invention are now described in detail.

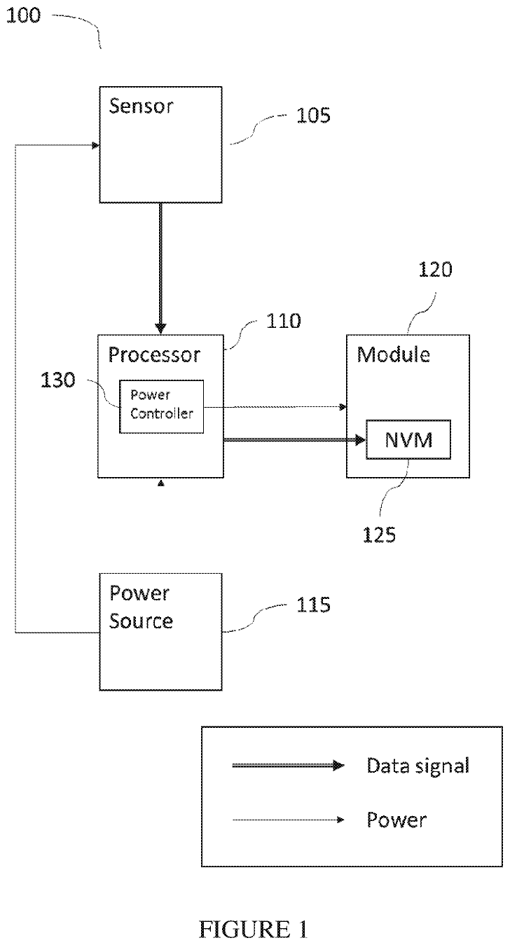

Reference is now made to FIG. 1, a block diagram of an ultra-low power circuit 100 for an event-recording smart label, according to some embodiments of the invention.

Circuit 100 comprises one or more sensors 105, a processor 110 comprising a power controller 130, a power source 115, and a module 120 comprising a non-volatile memory 125.

Sensor 105 can measure any physical quantity, such as temperature, proximity, acceleration, vibration, electrical properties, or magnetic field. Sensor 105 can be any type of sensor that provides a sensor signal that can be read, or adaptable to be read, by processor 110. Sensor 105 may or may not require externally applied power in order to operate.

Processor 110 can be any electronic device or group of devices receiving sensor signals from a sensor 105. Processor 110 determines an occurrence of a sensed event and digitally records a log of the sensed event. The term processor 110 as used herein includes any kind of logic processing unit, including but not limited to microcontrollers, microprocessors, and FPGAs. Processor 110 receives sensor signals from sensor 105.

Sensor 105 and processor 110 monitor the measured physical quantity and detect sensed events. A sensed event can be any significant condition or sequence of conditions measured by sensor 105. In some embodiments, processor 110 calculates whether the condition or sequence of conditions signifying a sensed event has occurred. Processor 110 records a log of the sensed event by writing to non-volatile memory 125.

Processor 110 may continuously monitor the sensor signal. In a preferred embodiment, however, monitoring of the sensor signal is triggered by some threshold level of sensor signal; for example, processor is normally in a sleep mode and a threshold level of sensor signal from sensor 105 wakes up processor 110. In another preferred embodiment, processor 110 is normally in sleep mode and is periodically awakened by a timer to measure the signal from sensor 105.

Power source 115 can be a power supply, a rechargeable battery, a disposable battery, or any combination thereof.

Module 120 is one or more components of circuit 100 besides sensor 105, processor 110, and power source 115. Module comprises a non-volatile memory (NVM) 125. NVM 125 can be any type of non-volatile memory that can be written to by processor 110 at least once, such as PROM, EPROM, EEPROM, flash memory, ferroelectric RAM, magneto-resistive RAM, or any combination thereof.

Processor 110 comprises a power controller 130. Power controller 130 may be integrated on a same chip as processor 110, or hybrid in a same package as processor 110, or in a separate package from processor 110. Power controller 130 may itself source current to power module 120 or may close a conductive path between power source 115 and module 120.

Power controller 130 normally supplies little or no power to module 120. When a sensed event is detected by processor 110, power controller 130 causes module 120 to be supplied with power. Supply of power to module 120 continues until processor 110 completes writing a log of the sensed event to NVM 125. After processor 110 completes writing the log of the sensed event to NVM 125, power controller 130 terminates supply of power to module 120, and module 120 thereby ceases to be powered.

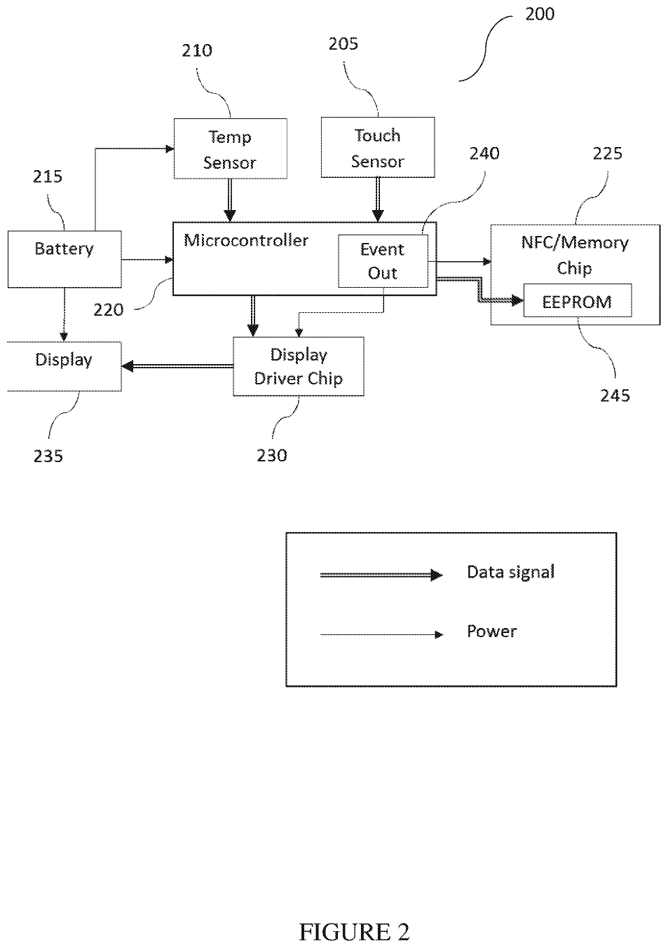

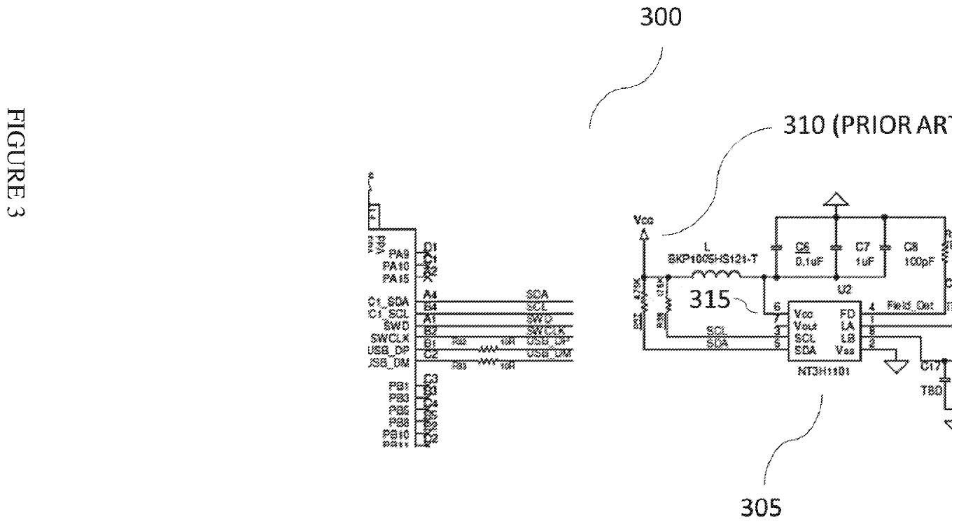

Reference is now made to FIG. 2, a block diagram of a power-saving event recorder circuit 200 of an event-recording smart label, according to some embodiments of the invention.

Power-saving event recorder circuit 200 of a smart label comprises one or more sensors, such as a touch sensor 205 (e.g. a capacitative sensor plate), a temperature sensor 210, and/or an accelerometer (not shown); a battery 215; a microcontroller 220, such as model STM32L052T6F6 microcontroller (STMicroelectronics NV, Amsterdam, The Netherlands); an NFC/memory chip 225 such as model NT3H1101 (NXP Semiconductors NV, Eindhoven, Netherlands); and, optionally, a display driver chip 230 and a display 235.

In an exemplary embodiment, a smart label with a temperature sensor 210 is placed on packaging of a food product (not shown). Microcontroller 220 receives signals from temperature sensor 210 and tracks time with its internal clock. Microcontroller 220 can calculate a thermal aging of the product with the product's aging acceleration due to exposure to heat over an interval of time. Upon making the calculation, microcontroller 220 drives an event-out pin 240 pin from a logical low to a logical high voltage. Event-out pin 240 is connected to input power pins of NFC/memory chip 225 and of display driver chip 230, thereby providing power to NFC/memory chip 225 and display driver chip 230 while event-out pin 240 is at the logical high voltage. Microcontroller 220 can add the calculated thermal aging to a previously stored thermal age in an EEPROM 245 of NFC/memory chip 225. Microcontroller 220 can send an updated expiration date (e.g., at a present temperature and/or at room temperature) to display driver chip 230. Display driver chip 230 then updates display 235. Microcontroller 220 receives confirmations that writing the updated thermal age to EEPROM 245 and updating of display 235 are complete; then microcontroller 220 drives voltage of event-out 240 from the logical high to the logical low voltage, thereby terminating supply of power to NFC/memory chip 225, display driver chip 230, and display 235.

Personnel taking inventory of goods can place a handheld NFC reader (not shown) near the smart label. NFC/memory chip 225 receives RF power from the NFC reader and harvests the RF power and supplies a DC power sufficient to power EEPROM 245, to read from EEPROM 245 data of an updated thermal age and/or the updated expiration date, and to wirelessly transmit the data to the NFC reader.

In another exemplary embodiment, a smart label with a capacitative touch sensor 205 is attached to an inhaler, such as an asthma inhaler (not shown). Capacitative touch sensor 205 is positioned on the inhaler where contact is made by fingers of a patient using the inhaler to administer a dose. Microcontroller 220 receives signals from capacitative touch sensor 205. Microcontroller 220 can normally be in a sleep mode and awaken upon receiving signal from capacitative touch sensor 205 indicating contact with touch sensor 205. Alternatively, or in addition, the microcontroller 220 awakes from the sleep mode at controlled time intervals (e.g. once per second) and reads the signal from capacitative touch sensor 205, in order to determine whether a contact is underway. When detecting a contact, microcontroller 220 then measures the duration of the contact using an internal timer. When the duration reaches a threshold duration (for example, a threshold duration in a range of one to five seconds, e.g. three seconds), microcontroller 220 determines by proxy that the inhaler has been actuated. Optionally, microcontroller 220 also receives signal from an accelerometer (not shown), where microcontroller 220 verifies that a vibration pattern indicative of an actuation is received from the accelerometer.

Upon detecting an actuation of the inhaler as herein described, microcontroller 220 drives voltage of event-out pin 240 from a logical low to a logical high voltage. Event-out pin 240 is electrically connected to input power pins of NFC/memory chip 225 and, optionally, of a display driver chip 230, thereby providing power to NFC/memory chip 225 and display driver chip 230 after the low-to-high transition. Microcontroller 220 writes a log of the event, e.g. a timestamp, in an EEPROM 245 of NFC/memory chip 225, and sends updated display data (e.g., a total number of actuations) to display driver chip 230. Microcontroller 220 receives confirmations that writing the log to EEPROM 245 and, optionally, updating of display 235 are complete; then microcontroller 220 drives voltage of event-out pin 240 from the logical high to the logical low voltage, thereby terminating supply of power to NFC/memory chip 225 and display driver chip 230.

Medical personnel attending to a patient using the inhaler can place the smart label near an NFC reader (not shown). NFC/memory chip 225 receives RF power from the NFC reader and harvests the RF power and supplies a DC power sufficient to power on EEPROM 245, read data from accumulated log files of actuations from EEPROM 245, and wirelessly transmit the data to the NFC reader.

In some preferred embodiments, microcontroller 220 is model STM32L052T6F6 (STMicroelectronics NV, Amsterdam, The Netherlands), which is known as a very low-current device and contains multiple timers. Advantageously, this device includes an internal temperature sensor 210 and an integral controller for a capacitative touch sensor 205, enabling the simple implementation of touch-sense functionality by adding touch sensor 205.

In some preferred embodiments, NFC/memory chip 225 is model NT3H1101 (NXP Semiconductors NV, Eindhoven, Netherlands), comprising an EEPROM 245 in which microcontroller 220 writes (and in some embodiments, reads) data, and to which data may also be written and/or read in passive mode by harvesting RF radiation from an external NFC reader to power up NFC/memory chip 225 in order to perform the read/write action externally over an NFC connection.

In order to reduce current consumption and allow use of a slim battery, microcontroller 220 is typically designed to spend almost all of its time in standby or sleep mode and only wake up to take care of events either on an interrupt-driven or time-driven basis. In a preferred embodiment, microcontroller 220 is programmed to be awake on a time-driven basis for a duty ratio of less than 1%; for example, for a duty time of 4 milliseconds every cycle time of 600 milliseconds, representing a duty ratio of 0.66%. The cycle time may be set to an elapsed time less than some minimum, such as less than 1 second, so as not to miss, for example, a handling event of an inhaler or a sudden change in temperature of a food product, as described herein. Using the STM32L052x6, current drain by microcontroller 220 during sleep mode is only 3 μA, rising to 110 μA for the duty time of 4 milliseconds. As the number of sensed events is expected to be very small compared to the number of cycles, the total average current drain is close to the sum of 3 μA+0.0066×110 μA=3.7 μA, which is a current consumption easily supported by a battery such as a CR2412 coin cell battery (Panasonic Corporation; Osaka, Japan, among other manufacturers) used in a preferred embodiment for a very long period.

The CR2412 is a lithium coin cell battery CR2412 with a typical capacity of 100 mAh. Its thickness is 1.2 mm, sufficiently thin for convenient incorporation of battery 215 in label type products. Different configurations of this type of battery can enable thinner batteries of 0.7-1.0 mm or even a little less, wherein the capacity would then be in the 50 mAh range, which may require a further reduction in average current drain, for example by increasing the cycle time or reducing the duty time.

In embodiments comprising a display 235, display 235 can be an e-paper display, such as one manufactured by E Ink Holdings (Hsinchu Science Park, Hsinchu 300, Taiwan). A major advantage of using an e-paper display as display 235 in event recorder 200 is that an e-paper display typically only consumes power when new display content is being written to the e-paper display. This content then remains on the screen until updated, without requiring an ongoing current drain. Assuming that any changes on the display for a label will be very infrequent, the average current drain from battery 215 due to display 235 is negligible.

However, an e-paper display (like most types of display) requires a display driver chip 230 to interface to microcontroller 220 and write the required data to the display. Unlike the display, the controller sinks an ongoing current drain. For example, the Texas Instruments TPS65186 PMIC controller for the E Ink® Vizplex™ display lists the current consumption in sleep mode as 3.5 μA (typical) and 10 μA (maximum). Additionally, the NFC/memory chip 225 (NT3H1101) sinks approximately 155 μA in all modes of operation. Together, display 235 and NFC/memory chip 225 produce a total ongoing current drain of approximately 162 μA (in addition to the occasional drain when some active function is being performed). A battery 215 such as a 100 mAh battery typically used in the present invention can support this level of current usage for only 100 mAh/162 mA=617 hours, which is just under 26 days. Supplying power to NFC/memory chip 225 and display driver chip 230 only when needed for an infrequent handling of a sensed event reduces the average current consumption by NFC/memory chip 225 and display driver chip 230 to a negligible level and significantly prolongs shelf life of an event-recording smart label.

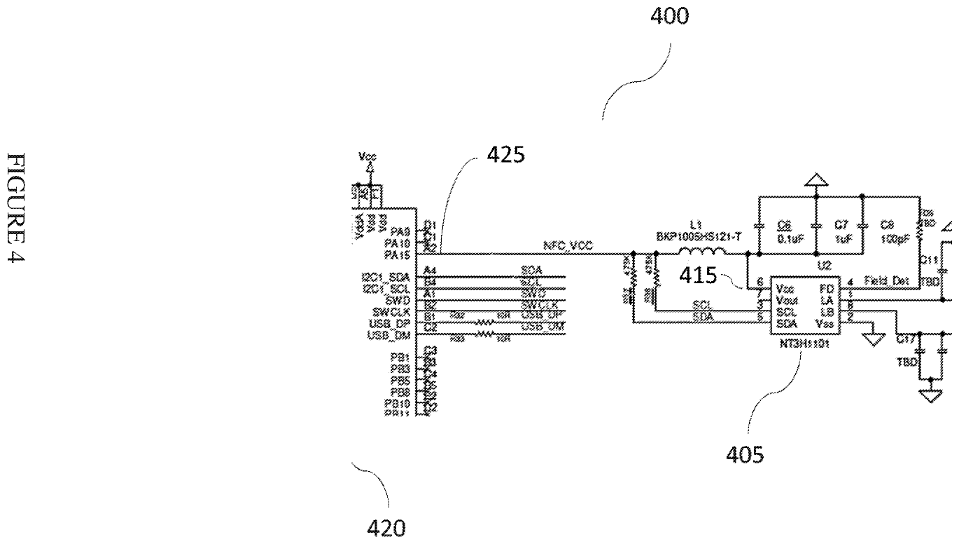

Reference is now made to FIG. 3, an electrical schematic of an event recorder circuit 300, using an approach for supplying power to integrated circuit chips that is typically used in the prior art. IC chips, including an NFC/memory chip 305 in event recorder circuit 300 are connected to the power rail 310, where for each such chip the V_{CC} pin 315 is connected to a suited power rail 310. This is the configuration that would lead to the short battery life of 26 days described herein.

Reference is now made to FIG. 4, an electrical schematic of an ultra-low power event recorder circuit 400, according to some embodiments of the invention. The current-minimizing approach of the present invention overcomes battery life limitation by altering the way in which IC chips surrounding microcontroller 420 receive their power voltage. Instead of being connected to the power rails, the V_{CC} pin of NFC/memory chip 405 is connected to an event-out pin 425 of microcontroller 420. Voltage of event-out pin 425 is normally at a logical low level. Event-out pin 425 switches to a logical high level periodiacally, as described herein, and remains logical high when microcontroller 420, receiving signal from sensor (not shown), determines occurrence of a sensed event. While at the logical high level, event-out pin 425 supplies power to NFC/memory chip 405, in order for EEPROM in NFC/memory chip 405 to receive log data from microcontroller 420 writing a log of the sensed event. Microcontroller 420 is configured (e.g., programmed) so that the voltage of event-out pin 425 remains logical high, thereby supplying power to NFC/memory chip 405, until receiving a confirmation that power is no longer needed. Confirmation can come from a write-busy flag of NFC/memory chip 405, indicating that writing to the EEPROM is complete. In some embodiments, microcontroller 420 is configured so that the logic level of event-out pin 425 remains at a logical high level until receiving both a confirmation that a display driver (not shown) has completed an update of a display, as well as a confirmation that writing to the EEPROM is complete. Upon receiving the confirmation(s), voltage of event-out pin 425 switches to a logic low level.

In this manner, NFC/memory chip 405 is powered by microcontroller 420 only when required and does not cause any current drain on an ongoing basis.

By connecting one or more IC chips—in some embodiments NFC/memory chip 405 and a display driver (not shown)—around microcontroller 420 in this manner, the current minimization during standby mode can significantly extend the shelf-life of an event-recording smart label. For example, in the embodiment shown, the only ongoing current drain (during standby) would be a 3.7 μA drain by microcontroller 420, enabling a battery life of 100 mAh/3.7 μA=27,027 hours from a CR2412 coin-cell battery (100 mAh capacity), which is 1,126 days or 3.1 years. Advantageously, in this manner, powering of a smart label according to the teachings of the invention enables the smart label to accompany a product with a shelf life of 1 to 2 years, which is impossible with consumption of the battery's capacity by NFC/memory chip 405 and the display driver in only 26 days of operation in standby mode, as calculated herein, if power is continuously applied to display driver and NFC/memory chip 405.

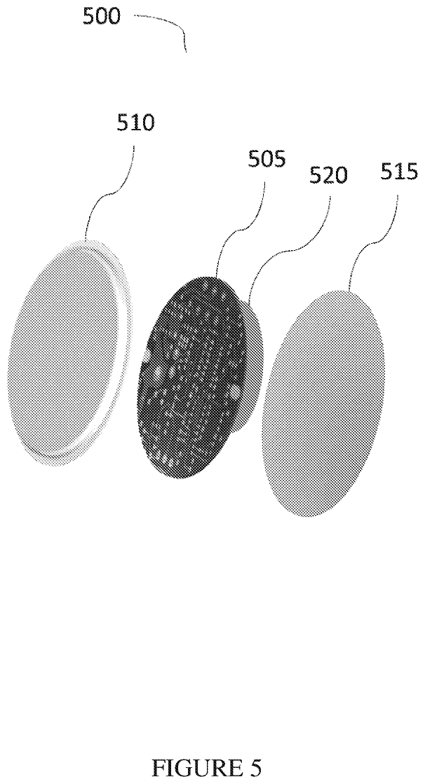

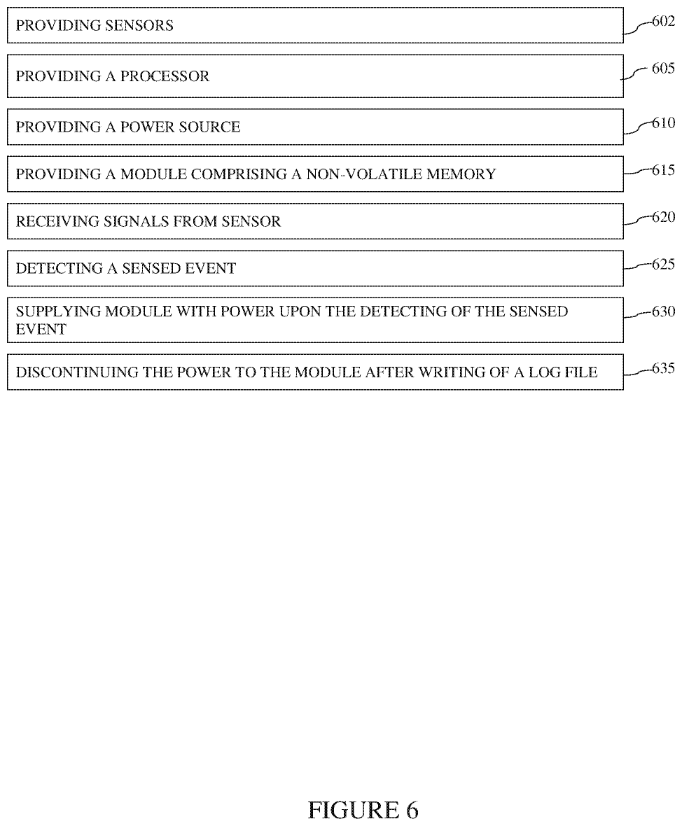

Reference is now made to FIG. 5, a physical layout of an event-recording smart label, 500 according to some preferred embodiments of the invention. The primary assemblies are a printed circuit board (PCB) 505, a front panel 510, an adhesive backing layer 515 which serves to attach the smart sensor label to a product, and a coin-cell battery 520 such as model CR2412 coin cell battery. Front panel 310 may contain a printed label (e.g. a printed product name and associated descriptive information), a display surface such as an e-paper display, or a combination thereof. Coin cell battery 520 may be mechanically embedded within a recess on the reverse side (not shown) of PCB 505, thereby minimizing the overall thickness of event-recording smart label 500. A capacitative sensor (not shown) can be printed on a layer of PCB 505.

Reference is now made to FIG. 6, showing a method 600 for providing an ultra-low power circuit for an event-recording smart label, comprising steps of
a. providing one or more sensors 602;
b. providing a processor 605;
c. providing a power source supplying the processor with a main power 610;
d. providing a module comprising a non-volatile memory 615;
e. receiving signals from the one or more sensors by the processor 620;
f. detecting a sensed event by the one or more sensors and the processor 625;
g. supplying the module with power, by a power controller of the processor, upon the detecting of a sensed event 630; and
h. discontinuing the power to the module after the processor writes a log of the sensed event to the non-volatile memory 635.

1. An ultra-low power circuit [100] for an event-recording smart label, comprising
a. one or more sensors [105];
b. a processor [110] configured to receive sensor signals from said sensor [105]; said sensor [105] and processor [105] configured to detect a sensed event;
c. a power source [115] providing said processor [110] with a main power;
d. a module [120] comprising a non-volatile memory [125], said non-volatile memory configured to store data received from said processor [110];
wherein said processor [110] comprises a power controller [130] in electrical connection with said module [120], configured to supply a module power to said module [120] upon a detection of said sensed event and further configured to discontinue said module power to said module [120] after said processor [110] writes a log of said sensed event to said non-volatile memory [125].

2. The circuit of claim 1, wherein said one or more sensors are selected from a group consisting of a capacitative touch sensor, a temperature sensor, an accelerometer, and any combination thereof.

3. The circuit of claim 1, wherein said module comprises an NFC/memory chip.

4. The circuit of claim 3, wherein said non-volatile memory is an EEPROM.

5. The circuit of claim 3, wherein said module further comprises a display driver; said display driver is configured to receive a display signal from said processor and to update a display in accordance with said display signal; said power controller further configured to discontinue said module power after said display driver updates said display.

6. The circuit of claim 5, wherein said display is an e-paper display.

7. The circuit of claim 1, wherein said module power is provided by an event-out pin of said processor.

8. The circuit of claim 2, wherein said sensed event is a touch to said capacitive sensor for a minimum time interval.

9. The circuit of claim 8, wherein said minimum time interval is about 1-5 seconds.

10. The circuit of claim 9, wherein said minimum time interval is about 3 seconds.

11. The circuit of claim 1, wherein said processor calculates an occurrence of said sensed event, as a function of said sensor signal over time.

12. A method for providing and ultra-low power circuit for an event recording smart label, comprising steps of
a. providing one or more sensors [602];
b. providing a processor [605];
c. providing a power source supplying said processor with a main power [610];
d. providing a module comprising a non-volatile memory [615];
e. receiving signals from said one or more sensors by said processor [620];
f. detecting a sensed event by said one or more sensors and said processor [625];
wherein said method further comprises steps of
g. supplying said module with power, by a power controller of said processor, upon said detecting of a sensed event [630]; and
h. discontinuing said power to said module after said processor writes a log of said sensed event to said non-volatile memory [635].
